(19) United States
(12) Patent Application Publication
(10) Pub. No.: US 2008/0190970 A1
(43) Pub. Date: Aug. 14, 2008

(54) Dosing system

(75) Inventor: Dennis T. Sanders, Trenton, TN (US)

Correspondence Address: Arthur L. Girard, PC, 8310 Poplar Hollow Trail, Richmond, VA, 23235, US

(73) Assignee: Pyrotek, Inc.

(21) Appl. No.: 11/705,654

(22) Filed: Feb. 13, 2007

(51) Int. Cl. B22D 35/06; B67D 5/08

(52) U.S. Cl. 222/593; 222/54

(57) ABSTRACT

A dosing system for the controlled feeding of liquids comprising: 1) a submersible centrifugal pump for insertion into a body of liquid to be dosed; 2) a riser rising angularly vertically from the centrifugal pump; 3) a receiver box at the terminus of the riser to receive liquid delivered thereto by the centrifugal pump via the riser; 4) a weir plate defining an exit from the receiver box to a delivery spout; 5) a sensor for measuring the depth of liquid in the receiver box; 6) at least one temperature sensor detecting the temperature of liquid within one or more locations within the dosing system; and 7) a control system receiving liquid depth and temperature data from the depth and temperature sensors and controlling the speed and thus the volume of the centrifugal pump as it feeds the riser and receiving box and hence the amount of liquid delivered to the delivery spout.

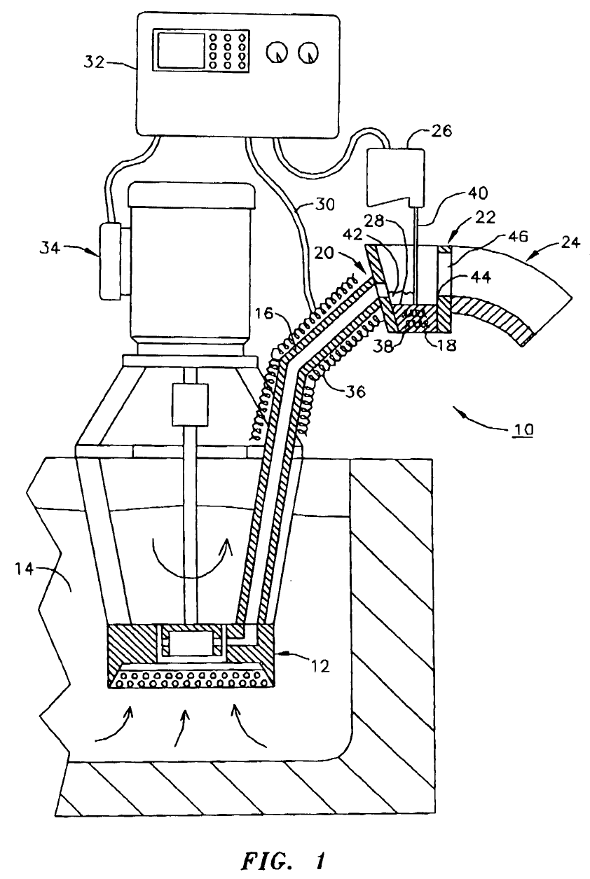

### FIELD OF THE INVENTION

The present invention relates to apparatus for controlling the feeding or dosing of liquids, and more particularly to such systems suitable for the controlled feeding of molten metals such as aluminum.

### BACKGROUND OF THE INVENTION

There are many commercial applications wherein the controlled feeding of relatively precise amounts of liquid is required. The liquid may be anything from water to reactive or treatment chemicals or even molten metals such as aluminum and iron such as are used in the foundry casting industry.

In such applications, relatively precise amounts of a liquid must be fed into a reaction or further processing site in an evenly distributed or controlled fashion to avoid a variety of undesirable results including operator and equipment damage, flooding etc.

While many such systems have been designed each of them demonstrates some shortcoming that makes their use difficult or very costly because of the complexity of the systems.

There therefore remains a continuing need for dosing systems that provide the necessary relatively precise controlled dosing of liquid that are relatively simple to operate and low maintenance.

### OBJECT OF THE INVENTION

It is therefore an object of the present invention to provide a liquid dosing system that is relatively simple in design and therefore easy to operate and maintain.

### SUMMARY OF THE INVENTION

According to the present invention, there is provided a dosing system for the controlled feeding of liquids comprising: 1) a submersible centrifugal pump for insertion into a body of liquid to be dosed; 2) a riser rising angularly vertically from the output side of the centrifugal pump; 3) a receiver box at the terminus of the riser to receive liquid delivered thereto by the centrifugal pump via the riser; 4) a weir plate defining an exit from the receiver box to a delivery spout; 5) a sensor for measuring the depth of liquid in the receiver box; 6) at least one temperature sensor detecting the temperature of liquid within various locations within the dosing system; and 7) a control system receiving liquid depth and temperature data from the depth and temperature sensors and controlling the speed and thus the volume of the centrifugal pump as it feeds the feeding tube and receiving box and hence the amount of liquid delivered to the delivery spout.

### DESCRIPTION OF THE DRAWINGS

The accompanying FIGURE is a cross sectional representation of the dosing system of the present invention.

### DETAILED DESCRIPTION

Referring now to the accompanying FIGURE, the dosing system 10 of the present invention comprises 1) a submersible centrifugal pump 12 for insertion into a body of liquid 14 to be dosed; 2) a riser 16 rising angularly vertically from the centrifugal pump 12; 3) a receiver box 18 at the terminus 20 of feed tube 16 to receive liquid delivered thereto by centrifugal pump 12 via riser 16; 4) a weir plate 22 defining an exit from receiver box 18 to a delivery spout 24; 5) a depth sensor 26 for measuring the depth of liquid 28 in receiver box 18; 6) at least one temperature sensor 30 detecting the temperature of liquid within one or more locations within dosing system 10; and 7) a control system 32 receiving liquid depth and temperature data from the depth and temperature sensors 26 and 30 and controlling the speed of a variable speed motor 34 driving centrifugal pump 12 and thus the delivery volume of centrifugal pump 12 as it feeds riser 16 and receiving box 18 and hence the amount of liquid delivered to delivery spout 24.

While dosing system 10 shown in the accompanying FIGURE and described above is suitable for the controlled delivery virtually any liquid, it is particularly suitable for the delivery of molten metal in, for example, the foundry industry. In such applications/installations. In such applications, it is desirable to provide the molten metal handling and transfer elements thereof, e.g. riser 16 and receiver box 18 with auxiliary heaters that help to maintain the temperature of the liquid metal as it passes through these various conduits. Such auxiliary heaters are shown as elements 36 and 38 in the accompanying FIGURE.

Liquid level sensor 26 may comprise any of a number of known systems useful in such applications. For example, a laser directing a beam 40 toward the surface of liquid 42 in receiver box 18 could be used. Similarly, a rod could replace laser beam 40 and a piece of ceramic foam that floats atop liquid 42 used to obtain the required liquid/molten metal depth information required to control the speed of variable speed motor 32 and hence the flow of liquid/molten metal to delivery spout 24.

While in the accompanying FIGURE only a single connection for the delivery of temperature data to control system 32, it will be readily apparent that depending upon the particular application/installation or its sophistication, it is possible and may be useful to derive temperature information from a plurality of locations within system 10.

This dosing system uses a simple centrifugal pump, a variable speed drive system, an open channel flow device and a PLC driven control system to provide accurate doses of metal even with varying conditions. The new dosing system 10 described herein provides a predicted flow by providing a controlled head level behind weir 22. The required liquid level is maintained regardless of the variables in the system, within the range of operation of the pumping system. A PID positive feedback loop system is used to control the speed of the pump so that the level is, as programmed. If the level falls below the set point, the motor speed is increased. These adjustments are made several times a second and only stop when the level is at the desired level or a preprogrammed min. or max. speed is exceeded. By being able to control the head level behind weir plate 22 the output flow is predicted and controlled. To achieve a desired dose of liquid the predicted flow is maintained for a programmed time period. By programming the head level and time periods the flow can be made to vary during the pour as required for any subsequent process.

Weir plate 22 is used as an open channel flow tool to measure the flow rate. In prior art systems, most weirs, used in flow measurement are applied to an unknown flow to measure the head restriction and predict the flow rate. Weir plate 22 of the present application varies the head level below the lowest point 44 in weir 22 to provide a readily available, but stopped flow of metal. Weir plate 22 may be provided with different opening widths to provide different calibrated flow rates at the same head levels. The shape of the weir opening 46 may also be varied to provide different flow curves based on the head level.

In the case of the application of system 10 to the delivery of molten metal such as aluminum in, for example a foundry operation, system 10 provides an inclined heated pipe, riser 16, to receiver box 18 that contains depth sensor 26 and weir plate 22. Receiver box 18 is preferably located at the point of utilization of the dosed liquid or molten metal. System 10 allows riser 16 to remain full of metal that is temperature controlled and protected from oxidation by the closed pipe. The metal will only be exposed to the atmosphere at receiver box 18 and the minimal spout 24 that directs the metal from weir opening 46. Thus, the metal is made to wait at receiver box 18, (point of use) instead of having a delayed response to the need for metal flow.

The only moving part to system 10 is the rotating shaft and rotor system of centrifugal pump 12. Unlike prior art metal delivery systems, no stopper rods are required to make fluid tight seals and no expensive coils are immersed in the metal. The preferred graphite pump systems used for centrifugal pump 12 have been providing highly reliable service for many years and can be a dependable method of providing flow.

As the invention has been described, it will be apparent to those skilled in the art that the same may be varied in many ways without departing from the intended spirit and scope of the invention, and any and all such modifications are intended to be included within the scope of the appended claims.

What is claimed is:

1) A liquid dosing system for the controlled feeding of liquids comprising:
a) a submersible centrifugal pump having an output for insertion into a body of liquid to be dosed;
b) a riser rising angularly vertically from the output having a terminus remote from the centrifugal pump;
c) a receiver box at the terminus to receive liquid delivered thereto by the centrifugal pump via the riser;
d) a weir plate defining an exit from the receiver box;
e) a delivery spout for the receipt of liquid from the receiver box and weir plate;
f) a sensor for measuring the depth of liquid in the receiver box;
g) at least one temperature sensor detecting the temperature of liquid within at least one location within the dosing system and feeding such temperature information to a control system; and
h) a control system receiving liquid depth and temperature data from the depth and temperature sensors and controlling the speed and thus the volume of the centrifugal pump as it feeds the riser and receiving box and hence the amount of liquid delivered to the delivery spout.

2) The liquid dosing system of claim 1 wherein the centrifugal pump is driven by a variable speed motor.

3) The liquid dosing system of claim 1 wherein the sensor for detecting the depth of the liquid in the receiver box is a laser sensor.

4) The liquid dosing system of claim 2 that is a molten metal dosing system and further includes heating elements in the receiver box and the riser for the purpose of maintaining temperature of molten metal passing therethrough.

5) The liquid dosing system of claim 3 wherein the sensor for detecting the depth of the liquid in the receiver box comprises a floating ceramic foam block that floats on molten metal in the receiver box attached to an inflexible rod that transmits the level of molten metal in the receiver box to a sensor.

6) The liquid dosing system of claim 3 wherein including a plurality of temperature sensors that detect the temperature of molten metal at various locations throughout the liquid dosing system.

7) The liquid dosing system of claim 3 wherein temperature sensors are located in the riser and the receiver box, the temperature sensors are connected to the controller providing temperature data to the controller for controlling the temperature of molten metal passing through the riser and the receiver box.

8) The liquid dosing system of claim 3 wherein the weir plate establishes minimum and maximum levels of metal in the receiver box.
